(19) United States
(12) Patent Application Publication
(10) Pub. No.: US 2006/0087916 A1
(43) Pub. Date: Apr. 27, 2006

(54) Food processor

(76) Inventors: Hsin-Yung Yang, Ta-Li City (TW); Hsin-Wen Lin, Kaohsiung City (TW); Nai-Wen Chang, Tainan City (TW)

Correspondence Address: LADAS & PARRY LLP, 224 SOUTH MICHIGAN AVENUE, SUITE 1600, CHICAGO, IL, 60604, US

(21) Appl. No.: 11/238,264

(22) Filed: Sep. 29, 2005

(30) Foreign Application Priority Data
Oct. 22, 2004 (TW) 93216906

(51) Int. Cl. B01F 7/00

(52) U.S. Cl. 366/314

(57) ABSTRACT

A cover member is adapted for use with a food processor, and includes a cover body formed with a straight rod passage and a food passage that branches from the rod passage. The rod passage has an open inner passage portion, and an open outer passage portion opposite to the inner passage portion in a vertical direction. The food passage has an open inlet end adjacent to the outer passage portion of the rod passage, an open outlet end in spatial communication with the inner passage portion of the rod passage, and a guide passage portion between the inlet and outlet ends. The guide passage portion is capable of guiding a food item fed into the food passage via the open inlet end to move into the inner passage portion of the rod passage via the open outlet end.

### CROSS-REFERENCE TO RELATED APPLICATION

This application claims priority of Taiwanese Application No. 093216906, filed on Oct. 22, 2004.

### BACKGROUND OF THE INVENTION

1. Field of the Invention

The invention relates to a food processor, more particularly to a food processor that is capable of enhancing safety and convenience during use.

2. Description of the Related Art

FIG. 1 illustrates a conventional food processor 1 that includes a base member 11, a container 12 mounted on the base member 11, a blade member 13 disposed in the container 12 and operable so as to process food items in the container 12, and a cover member 14 mounted on a top end of the container 12 to close the container 12. The cover member 14 has a cover body 141 mounted on the top end of the container 12, and a tubular wall 142 extending upwardly from the cover body 141. The tubular wall 142 confines a food passage 143 that is formed through the cover body 141. A press rod 15 extends into and is movable along the food passage 143.

In order to prevent the user's fingers from extending into the container 12 via the food passage 143 during use, for the sake of safety, the food passage 143 has a limited cross-section. Therefore, for certain food items, such as apples, potatoes and tomatoes, they must be cut first to fit into the food passage 143 before processing, thereby resulting in inconvenience during use.

### SUMMARY OF THE INVENTION

Therefore, the object of the present invention is to provide a food processor that can enhance safety and convenience during use.

According to one aspect of the present invention, a food processor comprises:

a processor base having a food-processing chamber;

a processing unit mounted in the processor base and including a blade member disposed in the food-processing chamber and operable so as to process food items in the food-processing chamber;

a cover member mounted on the processor base to close the food-processing chamber, the cover member being formed with a straight rod passage and a food passage that branches from the rod passage,

the rod passage being vertically aligned with the blade member and having an open inner passage portion proximate to the blade member, and an open outer passage portion opposite to the inner passage portion in a vertical direction,

the food passage having an open inlet end adjacent to the outer passage portion of the rod passage, an open outlet end in spatial communication with the inner passage portion of the rod passage, and a guide passage portion between the inlet and outlet ends, the guide passage portion being capable of guiding a food item fed into the food passage via the open inlet end to move into the inner passage portion of the rod passage via the open outlet end for processing by the blade member; and

a pressing rod unit extending into and movable along the vertical direction in the rod passage.

According to another aspect of the present invention, there is provided a cover member for a food processor. The cover member comprises a cover body formed with a straight rod passage and a food passage that branches from the rod passage.

The rod passage has an open inner passage portion, and an open outer passage portion opposite to the inner passage portion in a vertical direction.

The food passage has an open inlet end adjacent to the outer passage portion of the rod passage, an open outlet end in spatial communication with the inner passage portion of the rod passage, and a guide passage portion between the inlet and outlet ends. The guide passage portion is capable of guiding a food item fed into the food passage via the open inlet end to move into the inner passage portion of the rod passage via the open outlet end.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional food processor;

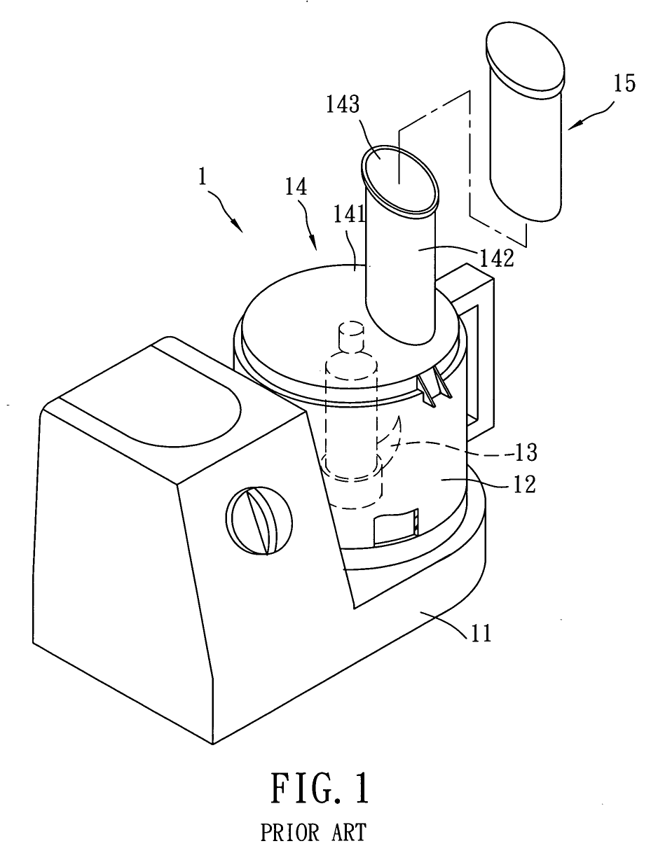

FIG. 2 is a partly exploded perspective view showing the preferred embodiment of a food processor according to the present invention;

FIG. 3 is a partly exploded, schematic sectional view showing the preferred embodiment;

FIG. 4 is an assembled schematic sectional view showing the preferred embodiment;

FIG. 5 is a fragmentary schematic sectional view showing the preferred embodiment when in a state of use; and

FIG. 6 is a fragmentary schematic sectional view showing the preferred embodiment when in another state of use.

### DETAILED DESCRIPTION OF THE PREFERRED EMBODIMENT

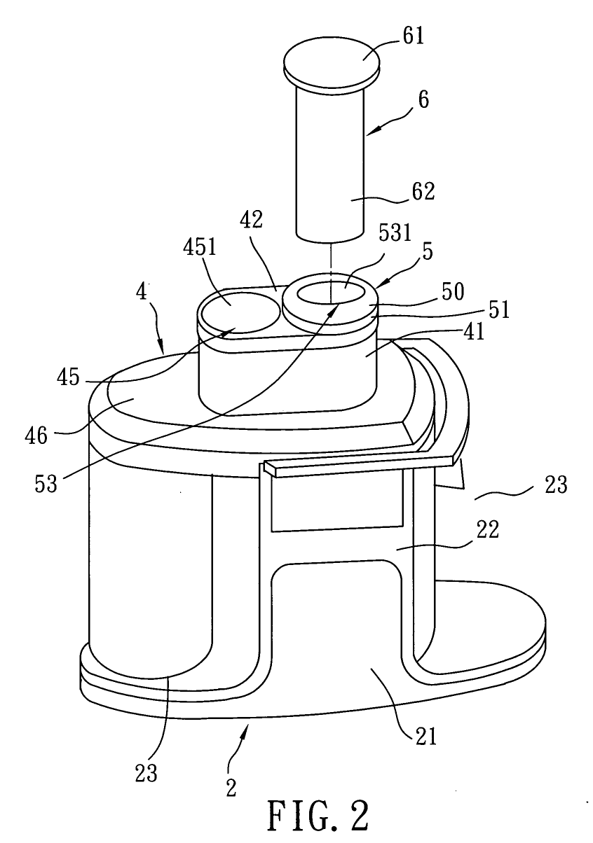

Referring to FIGS. 2 to 4, the preferred embodiment of a food processor according to the present invention is shown to include a processor base 2, a processing unit 3, a cover member 4, and a pressing rod unit.

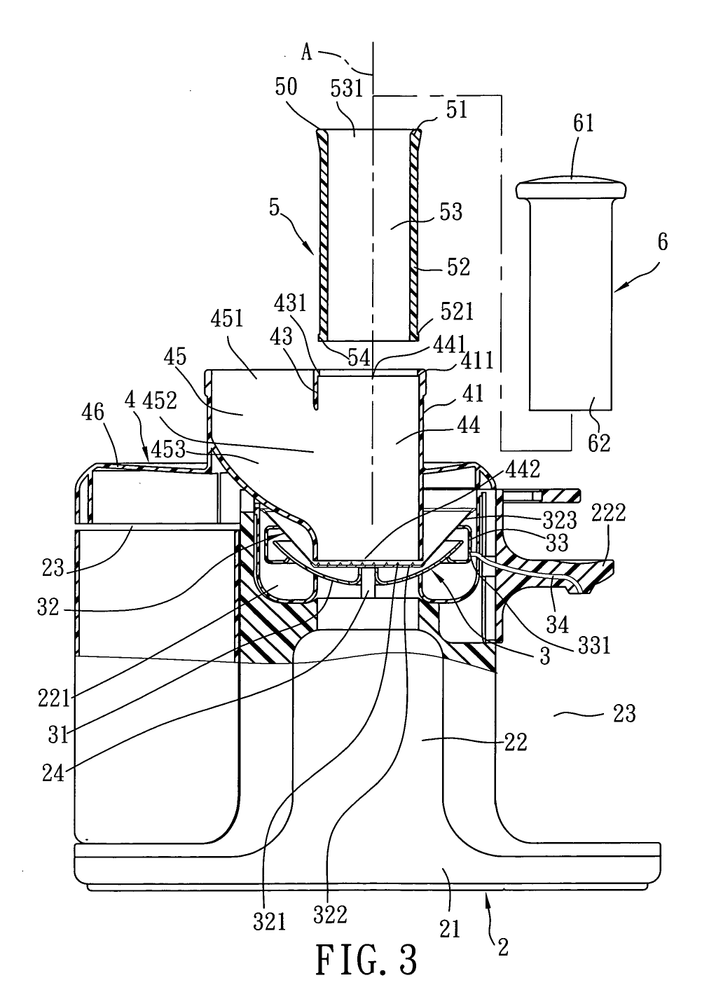

In this embodiment, as shown in FIG. 3, the processor base 2 has a base wall 21, a mounting portion 22 that extends upwardly from the base wall 21 and that has a top side formed with a food processing chamber 221, and a motor unit (not shown) that is mounted in the mounting portion 22 and that has a rotatable blade driving shaft 24 extending upwardly and outwardly of the mounting portion 22. The base wall 21 and the mounting portion 22 cooperate to confine opposite receiving spaces 23. An extension part 222 extends outwardly and horizontally from the mounting portion 22 and into one of the receiving spaces 23, as shown in FIG. 3.

In this embodiment, as shown in FIG. 3, the processing unit 3 is mounted in the food-processing chamber 221 in the mounting portion 22 of the processor base 2. The processing unit 3 includes a rotary dish 31 mounted on and co-rotatable with the blade driving shaft 24, a blade member 32 disposed above the rotary dish 31 in the food-processing chamber 221, co-rotatably coupled to the blade driving shaft 24 and operable so as to process food items in the food-processing chamber 221, and a juice-collecting member 33 mounted in the food-processing chamber 221 and disposed between the rotary dish 31 and the blade member 32 for collecting juice extracted from the food items processed by the blade member 32. In this embodiment, the blade member 32, which is also in a form of a dish, has a base wall 322 provided with a plurality of blades 321 thereon, and a perforated surrounding wall 323 connected to a periphery of the base wall 322, as shown in FIG. 3. The juice-collecting member 33 is formed with an outlet 331 connected to a conduit 34 that is embedded in the extension part 222, as shown in FIG. 3.

The cover member 4 is mounted on the processor base 2 to close the food-processing chamber 221. The cover member 4 includes a cover body formed with a straight rod passage 44 and a first food passage 45 that branches from the rod passage 44. In this embodiment, the cover body of the cover member 4 includes a surrounding wall 41, a top wall 42 connected to the surrounding wall 41, a partition wall 43 connected to the top wall 42, and a skirt portion 46 that extends outwardly from the surrounding wall 41 and that engages removably the processor base 2, as best shown in FIG. 3. It is noted that the surrounding wall 41, the top wall 42 and the partition wall 43 cooperate to confine the rod passage 44 and the first food passage 45.

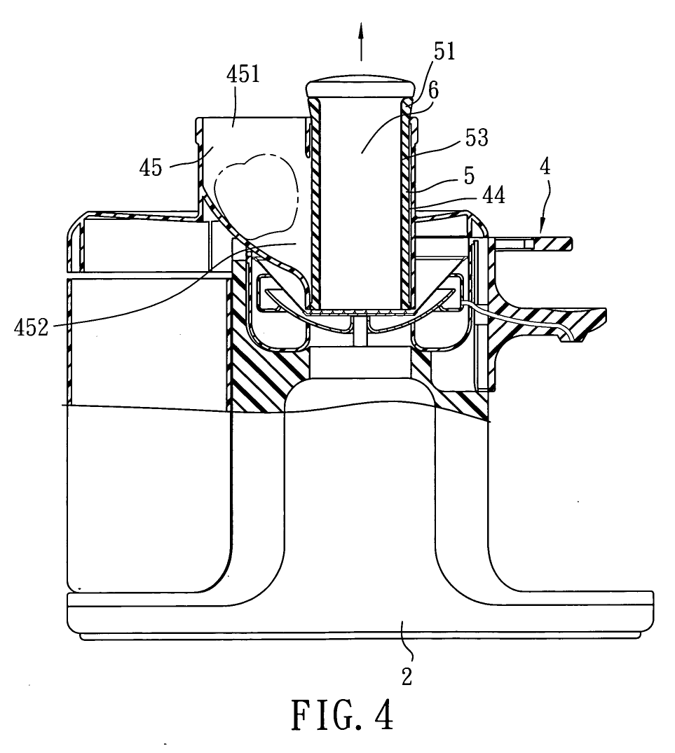

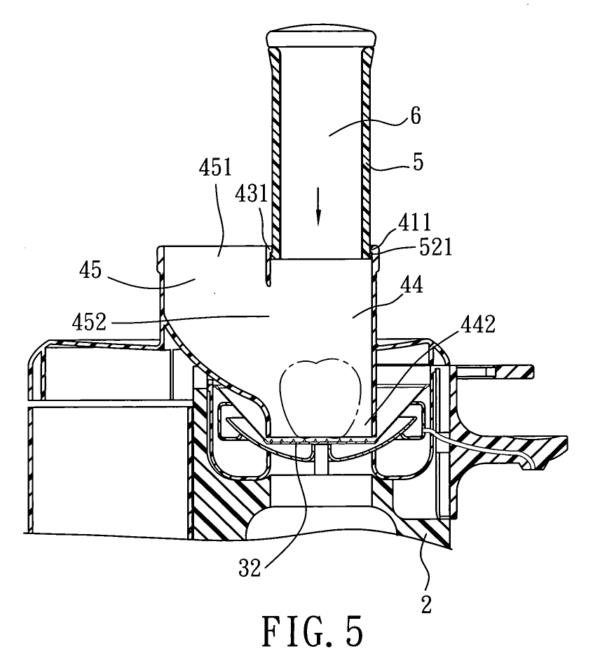

The rod passage 44 is vertically aligned with the blade member 32, and has an open inner passage portion 442 proximate to the base wall 322 of the blade member 32, and an open outer passage portion 441 opposite to the inner passage portion 442 in a vertical direction (A). The first food passage 45 has an open inlet end 451, which has a circular cross-section substantially equal to that of the inner passage portion 442 of the rod passage 44 in this embodiment, adjacent to the outer passage portion 441 of the rod passage 44, an open outlet end 452 in spatial communication with the inner passage portion 442 of the rod passage 44, and a guide passage portion 453 between the inlet and outlet ends 451, 452. The guide passage portion 453 is capable of guiding a food item fed into the first food passage 45 via the open inlet end 451 to move into the inner passage portion 442 of the rod passage 44 via the open outlet end 452 for processing by the blade member 32. As a result, the first food passage 45 permits passage of spherical food items, such as apples, therethrough without requiring cutting of the spherical food items before processing, as shown in FIGS. 4 and 5.

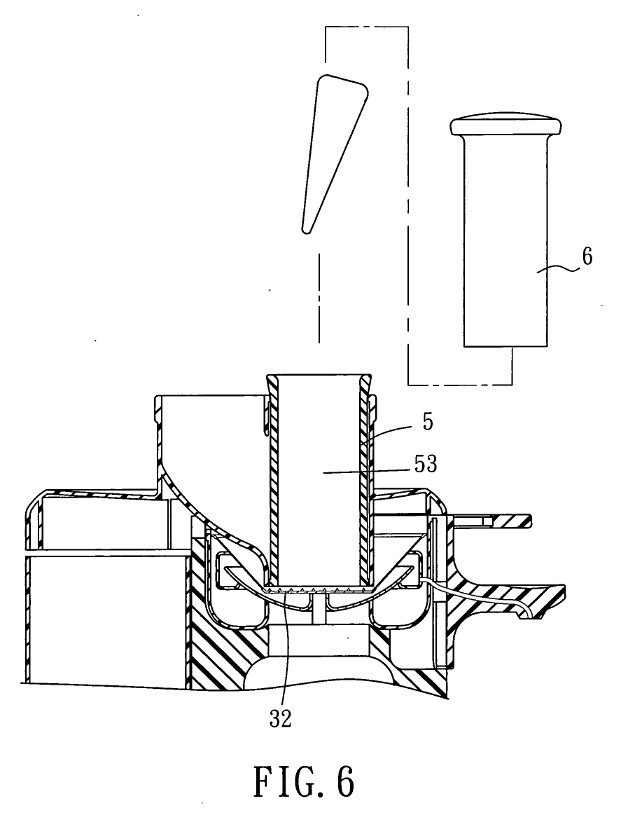

The pressing rod unit extends into and is movable along the vertical direction (A) in the rod passage 44. In this embodiment, as shown in FIG. 3, the pressing rod unit includes a tubular first rod 5, and a second rod 6. The first rod 5 has a tubular wall 52 that confines a second food passage 53. The second food passage 53 has an elliptical cross-section (best shown in FIG. 2) smaller than that of the first food passage 45. The tubular wall 52 has a top end 50 formed with a first stop 51 for seating on the top wall 42 of the cover member 4, and a bottom end 54 formed with a limit projection 521. The second food passage 53 has an open food inlet 531 formed through the top end 50 of the tubular wall 52. Furthermore, the cover member 4 is formed with a second stop 411, 431 that cooperates with the limit projection 521 to prevent upward removal of the first rod 5 from the rod passage 44, as shown in FIG. 5. The second rod 6 is extended removably into the second food passage 53, and has a head portion 61 seated removably on the top end 50 of the tubular wall 52 of the first rod 5, and a stem portion 62 that extends from the head portion 61 and that is disposed removably in the second food passage 53. As a result, the second food passage 53 is suitable for passage of long and thin food items, such as celery and carrot, therethrough, as shown in FIG. 6.

In actual use, the user selects one of the first and second food passages 45, 53, depending on the size and shape of the food item to be processed. With such a construction of the present invention, the second food passage 53 has a relatively small cross-section, thereby hindering extension of the user's fingers thereinto. Although the first food passage 45 has a relatively large cross-section, since the first food passage 45 branches from the rod passage 44, the user's fingers can be prevented from reaching the blade member 32 by the first rod 5, thereby enhancing safety during use. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A food processor comprising:
a processor base having a food-processing chamber;
a processing unit mounted in said processor base and including a blade member disposed in said food-processing chamber and operable so as to process food items in said food-processing chamber;
a cover member mounted on said processor base to close said food-processing chamber, said cover member being formed with a straight rod passage and a first food passage that branches from said rod passage,
said rod passage being vertically aligned with said blade member and having an open inner passage portion proximate to said blade member, and an open outer passage portion opposite to said inner passage portion in a vertical direction,
said first food passage having an open inlet end adjacent to said outer passage portion of said rod passage, an open outlet end in spatial communication with said inner passage portion of said rod passage, and a guide passage portion between said inlet and outlet ends, said guide passage portion being capable of guiding a food item fed into said first food passage via said open inlet end to move into said inner passage portion of said rod passage via said open outlet end for processing by said blade member; and
a pressing rod unit extending into and movable along the vertical direction in said rod passage.

2. The food processor as claimed in claim 1, wherein said cover member includes a cover body having a surrounding wall, a top wall connected to said surrounding wall, and a partition wall connected to said top wall,
said surrounding wall, said top wall and said partition wall cooperating to confine said rod passage and said first food passage,
said outer passage portion of said rod passage and said open inlet end of said first food passage being formed through said top wall.

3. The food processor as claimed in claim 2, wherein said cover body further has a skirt portion that extends outwardly from said surrounding wall and that engages removably said processor base.

4. The food processor as claimed in claim 1, wherein said pressing rod unit includes a tubular first rod, said first rod having a tubular wall that confines a second food passage, said second food passage having a cross-section smaller than that of said first food passage.

5. The food processor as claimed in claim 4, wherein said cover member includes a surrounding wall, a top wall connected to said surrounding wall, and a partition wall connected to said top wall,
said surrounding wall, said top wall and said partition wall cooperating to confine said rod passage and said first food passage,
said tubular wall of said first rod having a top end formed with a first stop for seating on said top wall,
said second food passage having an open food inlet formed through said top end of said tubular wall of said first rod.

6. The food processor as claimed in claim 5, wherein said cover member is formed with a second stop at a periphery of said outer passage portion of said rod passage,
said tubular wall of said first rod further having a bottom end formed with a limit projection that cooperates with said second stop to prevent upward removal of said first rod from said rod passage.

7. The food processor as claimed in claim 4, wherein said pressing rod unit further includes a second rod extended removably into said second food passage.

8. The food processor as claimed in claim 7, wherein said tubular wall of said first rod has a top end, said second rod having a head portion seated removably on said top end of said tubular wall of said first rod, and a stem portion that extends from said head portion and that is disposed removably in said second food passage.

9. A cover member for a food processor, said cover member comprising a cover body formed with a straight rod passage and a food passage that branches from said rod passage,
said rod passage having an open inner passage portion, and an open outer passage portion opposite to said inner passage portion in a vertical direction,
said food passage having an open inlet end adjacent to said outer passage portion of said rod passage, an open outlet end in spatial communication with said inner passage portion of said rod passage, and a guide passage portion between said inlet and outlet ends, said guide passage portion being capable of guiding a food item fed into said food passage via said open inlet end to move into said inner passage portion of said rod passage via said open outlet end.

10. The cover member as claimed in claim 9, wherein said cover body has a surrounding wall, a top wall connected to said surrounding wall, and a partition wall connected to said top wall,
said surrounding wall, said top wall and said partition wall cooperating to confine said rod passage and said food passage,
said outer passage portion of said rod portion and said open inlet end of said food passage being formed through said top wall.
